(19) United States
(12) Patent Application Publication
(10) Pub. No.: US 2015/0077357 A1
(43) Pub. Date: Mar. 19, 2015

(54) DISPLAY APPARATUS AND CONTROL METHOD THEREOF

(71) Applicant: Samsung Electronics Co., Ltd., Suwon-si (KR)

(72) Inventor: Jae-ryong HAN, Cheonan-si (KR)

(73) Assignee: SAMSUNG ELECTRONICS CO., LTD., Suwon-si (KR)

(21) Appl. No.: 14/337,801

(22) Filed: Jul. 22, 2014

(30) Foreign Application Priority Data
Sep. 17, 2013 (KR) 10-2013-0111921

(51) Int. Cl. G06F 3/041; G06F 3/01

(52) U.S. Cl. CPC G06F 3/041; G06F 3/013; G06F 2203/04104
USPC 345/173

(57) ABSTRACT

Disclosed are a display apparatus and a control method thereof, the display apparatus including: a display section which displays an image; a touch detecting section which receives a plurality of touch inputs from a user; an image input section which receives an image; and a controller which performs operations corresponding to the plurality of received touch inputs using information of the touch inputs received through the touch detecting section and eye-gaze information of the user received through the image input section. Thus it is possible to identify a user using an eye-gaze direction of the user for plural touch inputs to perform an operation corresponding to a touch input of the identified user, to thereby provide a display apparatus capable of distinguishing plural touch inputs of plural users.

### CROSS-REFERENCE TO RELATED APPLICATIONS

This application claims priority benefit from Korean Patent Application No. 10-2013-0111921, filed on Sep. 17, 2013 in the Korean Intellectual Property Office, the disclosure of which is incorporated herein by reference.

### BACKGROUND

1. Field

Apparatuses and methods consistent with the exemplary embodiments relate to a display apparatus and a control method thereof, and more particularly, to a display apparatus which detects plural touch inputs received from a user, and a control method thereof.

2. Description of the Related Art

A display apparatus displays an image based on an image signal generated therein or received from an external device. The display apparatus includes a display panel which displays the image, and may be provided with a combination of various input devices for user input. For example, the display apparatus receives various commands through various input devices provided as a user input section, and performs corresponding operations.

The user input section may include a remote controller, a touch screen, a touch pad or the like provided with a touch detecting section, and a user may manipulate the touch detecting section while viewing a screen of the display apparatus to perform user input.

Recently, a touch detecting section capable of detecting multi touches or plural touch inputs in addition to a single touch and further supporting multi touches of multi users has been proposed. That is, application of the touch detecting section has been enlarged.

However, in the related art, the touch detecting section is generally operated without distinction of various users, that is, provides a technique based on a single user. That is, the display apparatus detects a user's touch input on the basis of information calculated using the number of touch inputs to the touch detecting section, the moving direction and speed of each touch input, and the like.

Thus, in a multi-user environment including plural users, the display apparatus cannot distinguish plural touch inputs of the plural users, which may cause an operational error.

In order to solve the above problem, a method of assigning an input area of a touch detecting section for each user, a method of selecting a user before touch input, or the like has been attempted, but these methods should perform an additional operation, which may cause inconvenience to users. Further, when touch inputs of different users occur in adjacent areas or in the same area, it is difficult to apply these methods.

### SUMMARY

Additional aspects and/or advantages will be set forth in part in the description which follows and, in part, will be apparent from the description, or may be learned by practice of the invention.

One or more exemplary embodiments may provide a display apparatus including: a display section which displays an image; a touch detecting section which receives a plurality of touch inputs from a user; an image input section which receives an image; and a controller which performs operations corresponding to the plurality of received touch inputs using information of the touch inputs received through the touch detecting section and eye-gaze information on the user received through the image input section.

The eye-gaze information may include one of face direction information and/or pupil direction information.

The controller may determine whether a touch input at a position corresponding to a face direction or a pupil direction is present for each of the plurality of touch inputs, and identify a user corresponding to each of the plurality of touch inputs on the basis of the determination.

The display apparatus may further includes a storage section which stores a matching table for determination of the face direction or the pupil direction, and the controller may acquire information from a user image received through the image input section, and load a face direction or a pupil direction which matches with the acquired information from the matching table to determine the eye-gaze direction of the user.

In a case where the eye-gaze information is the pupil direction information, the controller may acquire information on horizontal and vertical lengths between the edge of a pupil of a user's eye and the edge of a white thereof from the user image, and load a pupil direction which matches with the acquired information on the lengths from the matching table to determine the pupil direction of the user.

The eye-gaze direction of the user may include directions of right, left, up, down, center, left-up, right-up, left-down and right-down, which are distinctly stored in the matching table.

In a case where the eye-gaze information is the face direction information, the controller may determine the face direction of the user using at least one of a horizontal position, a vertical position and a rotational angle of a face in the user image received through the image input section.

The storage section further may stores a history of matching for the face direction and/or the pupil direction of the user.

The controller may determine a touch input of which the position matches with an eye-gaze direction corresponding to the eye-gaze information, among the plurality of touch inputs, as a valid touch input.

The controller may identify the type of the valid touch input, perform an operation corresponding to the identified type of the valid touch input, and control the display section to display an image corresponding to the performed operation.

The valid touch input may include a first touch input for a first object and a second touch input for a second object, and the controller may perform an operation corresponding to the first touch input for the first object and perform an operation corresponding to the second touch input for the second object.

According to an aspect of an exemplary embodiment, a control method of a display apparatus, including: receiving a plurality of touch inputs from a user; receiving eye-gaze information of the user; and performing operations corresponding to the plurality of received touch inputs using information of the received touch inputs and the eye-gaze information of the user is provided.

The eye-gaze information may include at least one of face direction information and pupil direction information.

The method may further include determining whether a touch input at a position corresponding to a face direction or a pupil direction is present for each of the plurality of touch inputs; and identifying a user corresponding to each of the plurality of touch inputs on the basis of the determination.

The method may further include storing a matching table for determination of the face direction or the pupil direction, and the determination of the presence of the touch input may include acquiring information from a user image, and loading a face direction or a pupil direction which matches with the acquired information from the matching table to determine the eye-gaze direction of the user.

In a case where the eye-gaze information is the pupil direction information, the acquisition of the information may include acquiring information on horizontal and vertical lengths between the edge of a pupil of a user's eye and the edge of a white thereof from the user image, and the determination of the eye-gaze direction may include loading a pupil direction which matches with the acquired information on the lengths from the matching table to determine the pupil direction of the user.

The eye-gaze direction of the user may include directions of right, left, up, down, center, left-up, right-up, left-down and right-down, which are distinctly stored in the matching table.

In a case where the eye-gaze information is the face direction information, the determination of the eye-gaze direction may include determining the face direction of the user using at least one of a horizontal position, a vertical position and a rotational angle of a face in the user image.

The method may further include storing a history of matching for the face direction and/or the pupil direction of the user.

The method may further include determining a touch input of which the position matches with an eye-gaze direction corresponding to the eye-gaze information, among the plurality of touch inputs, as a valid touch input.

The method may further include identifying the type of the valid touch input; performing an operation corresponding to the identified type of the valid touch input; and displaying an image corresponding to the performed operation.

The valid touch input may includes a first touch input for a first object and a second touch input for a second object, and the performance of the operation may include performing an operation corresponding to the first touch input for the first object and performing an operation corresponding to the second touch input for the second object.

### BRIEF DESCRIPTION OF THE DRAWINGS

The above and/or other aspects will become apparent and more readily appreciated from the following description of exemplary embodiments, taken in conjunction with the accompanying drawings, in which:

FIG. 1 is a block diagram illustrating a configuration of a display apparatus according to an exemplary embodiment.

FIGS. 2A-2D illustrate examples of a user touch input detected in a display apparatus according to an exemplary embodiment.

FIG. 3 illustrates an example of a matching table stored in a display apparatus according to an exemplary embodiment.

FIG. 4 illustrates a process of identifying users of plural touch inputs in a display apparatus according to an exemplary embodiment.

FIGS. 5A-5B illustrate examples in which users of plural touch inputs are identified in the process in FIG. 4.

FIG. 6 is a flowchart illustrating a control method of a display apparatus according to an exemplary embodiment.

### DETAILED DESCRIPTION

Reference will now be made in detail to the embodiments, examples of which are illustrated in the accompanying drawings, wherein like reference numerals refer to the like elements throughout. The embodiments are described below to explain the present invention by referring to the figures.

Below, exemplary embodiments will be described in detail with reference to accompanying drawings so as to be easily realized by a person having ordinary knowledge in the art. The exemplary embodiments may be embodied in various forms without being limited to the exemplary embodiments set forth herein. Descriptions of well-known parts are omitted for clarity, and like reference numerals refer to like elements throughout.

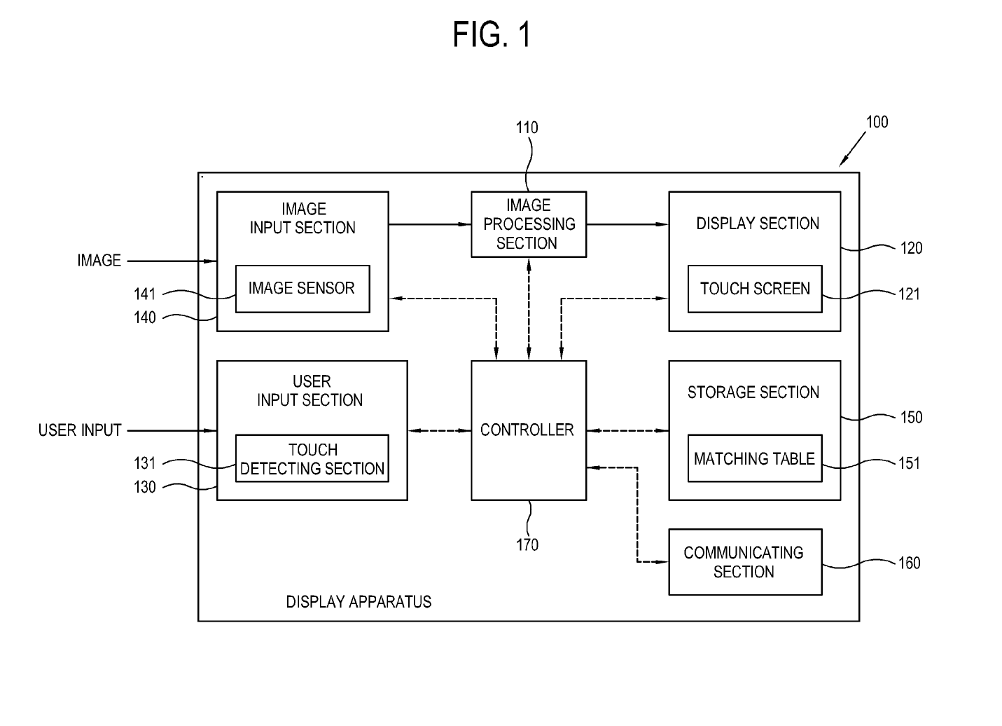

FIG. 1 is a block diagram illustrating a configuration of a display apparatus 100 according to an exemplary embodiment,

The display apparatus 100 according to the present embodiment processes an image signal according to predetermined processes to display an image. In the present embodiment, a case where the display apparatus 100 is realized as a television which displays a broadcast image on the basis of a broadcast signal, broadcast information or broadcast data received from a transmitter of a broadcasting station will be described as an example. Here, the display apparatus 100 may display various images such as video or a still image based on a signal or data received from various image sources, an application program, an on-screen display (OSD), or a user interface (UI) or a graphic user interface (GUI), as well as the broadcast image.

The spirit of the present disclosure may be applied to a display apparatus different from the display apparatus 100 of the present embodiment, such as a monitor connected to a computer, a large-sized display such as an interactive whiteboard (IWB) or a tabletop display, a mobile device such as a tablet PC or a smart phone, a digital signage which employs plural display apparatuses, or a large format display (LFD). That is, the present embodiment described below is only exemplary, and thus, may be modified in various forms according to the type of a realized system without departing from the scope of claims.

Hereinafter, a specific configuration of the display apparatus 100 will be described.

As shown in FIG. 1, the display apparatus 100 includes an image processing section 110 which processes an image signal received from an external device (not shown), a display section 120 which displays an image on the basis of the image signal processed by the image processing section 110, a user input section 130 through which a user input is received, an image input section 140 through which an image is input, a storage section 150 which stores a variety of data, a communicating section 160 which performs communication with the external device, and a controller 170 which controls overall operations of the display apparatus 100.

The image processing section 110 processes an image signal according to predetermined processes. The image processing section 110 outputs the processed image signal to the display section 120 so that the display section 120 displays an image.

In this regard, the image processing section 110 may include an image receiving section which receives an image signal from the external device. The image processing section 110 may be realized in various forms according to the standard of the received image signal and the type of the display apparatus 100. For example, the image processing section 110 may receive a radio frequency (RF) signal transmitted from a broadcasting station in a wireless manner, or may receive an image signal based on composite video, component video, super video, SCART (Radio and Television Receiver Manufacturers' Association), high definition multimedia interface (HDMI) or the like, in a wired manner. In a case where the image signal is a broadcast signal, the image processing section 110 may include a tuner which tunes the broadcast signal for each channel.

The image signal may be input from an external device such as a personal computer, an audio/video device, a smart phone or a smart pad. Further, the image signal may be obtained from data received through a network such as the Internet. In this case, the display apparatus 100 may perform network communication through the communicating section 160, or may further include a separate network communicating section. Further, the image signal may be obtained from data stored in the non-volatile storage section 150 such as a flash memory or a hard disk. The storage section 150 may be provided inside or outside the display apparatus 100. In a case where the storage section 150 is provided outside the display apparatus 100, the display apparatus 100 may further include a connecting section (not shown) to which the storage section 150 is connected.

The types of processes performed by the image processing section 110 are not particularly limited, and for example, may include decoding suitable for various image formats, de-interlacing, frame refresh rate conversion, scaling, noise reduction for improvement of image quality, detail enhancement, line scanning and the like. The image processing section 110 may be realized as individual component groups capable of individually performing these processes, or may be realized as a system-on-chip (SOC) with integrated functions of the processes.

The image processing section 110 according to the present embodiment may further process an image obtained through an image sensor 141 of the image input section 140. In this regard, the controller 170 may identify users of plural touch inputs (to be described later) using eye-gaze information, that is, using face direction information and/or pupil direction information (information on a recognition direction of a pupil), and may perform operations corresponding to the touch inputs.

The display section 120 displays an image on the basis of the image signal processed by the image processing section 110. The display section 120 is not particularly limited in its type, and may be realized as various types of displays which use liquid crystal, plasma, light-emitting diodes, organic light-emitting diodes, a surface-conduction electron-emitter, carbon nano-tubes, nano-crystal or the like.

The display section 120 may include an additional configuration according to its display type. For example, in a case where the display section 120 is a liquid crystal type, the display section 120 may include a liquid crystal panel (not shown), a backlight unit (not shown) which supplies light to the liquid crystal panel, and a panel drive board (not shown) which drives the panel.

The display section 120 according to the present embodiment may include a touch screen 121 through which a touch input of a user is received. The touch screen 121 may be provided as a user interface (UI), which may display icons including menu options of the display apparatus 100. The user may touch any one of icons displayed on the touch screen 121 for user input.

The user input section 130 transmits various predetermined control commands or arbitrary information to the controller 170 according to manipulation and input of a user.

The user input section 130 includes a touch detecting section 131 which receives a touch input of a user. Thus, the display apparatus 100 may control an image displayed in the display section 120 according to information on the touch input of the user received by the touch detecting section 130.

The touch detecting section 130 includes a touch pad (or a touch interface) provided in a main body of the display apparatus 100 or provided in an input device separated from the main body, such as a remote controller that generates a predetermined command, data, information or signal and transmits the result to the display apparatus 100 to remotely control the display apparatus 100 or a keyboard. The input device is an external device capable of performing wireless communication with the display apparatus 100. The wireless communication includes infrared communication, RF communication, wireless local area network (LAN) communication or the like. The input device transmits a predetermined command to the display apparatus 100 according to manipulation of the user.

Further, the touch detecting section 131 may include the touch screen 121 provided in the display section 120. For example, the touch screen 121 may be realized in a resistive type, a capacitive type, an infrared type or an acoustic wave type.

The touch screen 121 may receive a touch input of a user through a bodily portion (for example, a finger) of the user or a pointing device (not shown). The pointing device may include a stylus, a haptic pen in which a built-in vibrator element (for example, a vibrating motor or an actuator) generates vibration using control information received from the communicating section 160, or the like. The user may select various graphic user interfaces (GUIs) such as texts or icons displayed on the touch screen 121 for user's selection, using the pointing device or the finger.

The touch screen 121 may provide a GUI corresponding to various services (for example, telephone calls, data transmission, broadcasting, photographing, video, or application programs) to the user. The touch screen 121 transmits an analog signal corresponding to a single touch or multi touches input through the GUI to the controller 170.

In the present embodiment, the touch is not limited to contact between the touch screen 121 and the bodily portion of the user or the pointing device, and may include non-contact, for example, hovering in which a detectable gap between the touch screen 121 and the bodily portion of the user or the pointing device is 30 mm or less. Here, the detectable non-contact gap may be varied according to the performance or structure of the display apparatus 100.

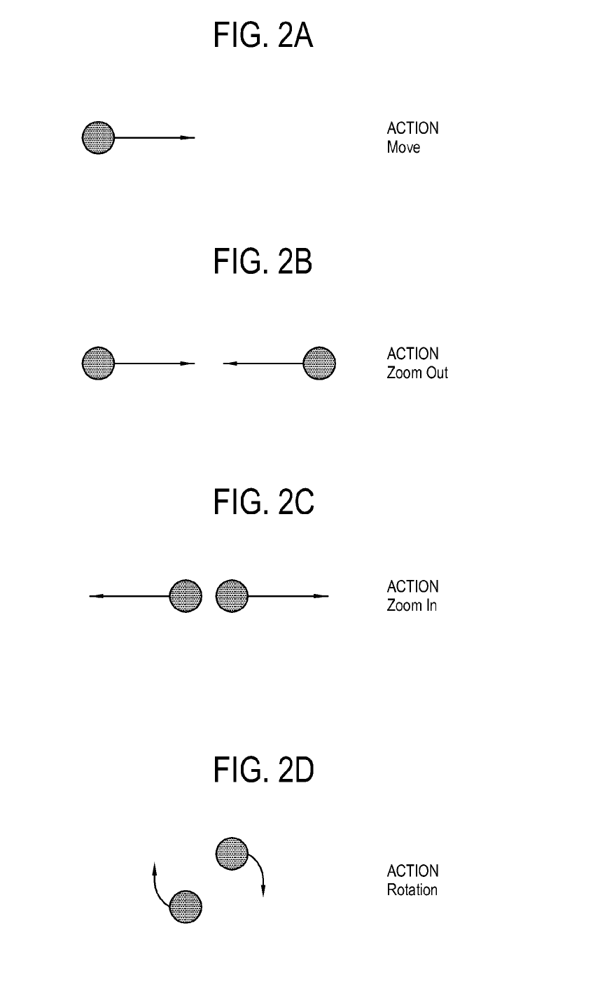

FIGS. 2A-2D illustrate an example of a touch input of a user detected in the display apparatus 100 according to the present embodiment.

As shown in FIGS. 2A-2D, a touch input detected in the touch detecting section 131 may include “Move”, “Zoom Out” and “Zoom In” using multi touches, “Rotation” (d), respectively.

Here, “Move”, “Zoom Out”, “Zoom In” and “Rotation” may be performed by drag, flick, drag and drop, tap, long tap, and etc.

The drag refers to an operation of a user in which the user moves his/her finger or a pointing device to a different position on a screen with the finger or pointing device being in touch with a specific position on the screen. A selected object may be moved due to the drag. Further, when the user touches the screen and performs the drag without selection of an object on the screen, the screen is moved or a different screen is displayed due to the drag.

The flick refers to an operation of a user in which the user performs drag at a critical speed (for example, 100 pixels per second) or higher using his/her finger or a pointing device. The drag and the flick may be distinguished by comparing the moving speed of the finger or pointing device with the critical speed.

The drag and drop refers to an operation of a user in which the user selects an object using his/her finger or a pointing device and drags and drops the selected object to a different position on a screen. The selected object is moved to the different position due to the drag and drop.

The tap refers to an operation of a user in which the user rapidly touches a screen using his/her finger or a pointing device. In this case, a touch time, that is, a time difference between a time point when the finger or pointing device touches the screen and a time point when the finger or pointing device is separated from the screen after the touch is very short.

The long tap refers to an operation of a user in which the user touches a screen for a predetermined time or longer using his/her finger or a pointing device. In this case, a touch time, that is, a time difference between a time point when the finger or pointing device touches the screen and a time point when the finger or pointing device is separated from the screen after the touch is longer than that of the tap. The controller 160 may distinguish the tap and the long tap by comparing the touch time with a predetermined reference time.

An aspect of the present embodiment, the touch detecting section 131 may detect various touch inputs of plural users, as described above. The controller 170 may distinctly recognize each detected touch input for each user using eye-gaze information of the user (hereinafter, may be referred to as eye-gaze direction information) to be described later.

On the other hand, the user input section 130 according to the present embodiment may further include, in addition to the touch detecting section 131, a motion detecting section (not shown) which is provided in a remote controller and detects a motion of a user, a button input section (not shown) including buttons such as numeral keys and menu keys provided in the main body of the display apparatus 100 or provided in the input device separated from the main body, and the like. The motion detecting section may include a gyro sensor, an angular velocity sensor, a geomagnetic sensor, or the like.

The image input section 140 is realized as a camera (for example, a web camera) which captures an image from the outside. The image input section 140 is not particularly limited in its installation position, and may be provided at an arbitrary position such as an upper portion of the display apparatus 100, or may be provided at an external place separated from the main body of the display apparatus 100 as necessary.

The image input section 140 may include a lens (not shown) through which an image passes and an image sensor 141 that detects the image passed through the lens. The image sensor 141 may include a charge-coupled device (CCD) or a complementary metal-oxide-semiconductor (CMOS).

The image input section 140 according to the present embodiment may receive plural user images. The received user images are processed by the image processing section 110. The controller 170 may acquire eye-gaze information (that is, face direction information and/or pupil direction information) of the plural users from the images processed by the image processing section 110. The controller 170 determines the positions of the users using the acquired eye-gaze direction information of the users, and distinctly recognizes touch inputs of the plural users, according to the users, using the determined positions.

The storage section 150 stores arbitrary data under the control of the controller 170. The storage section 150 may be realized as a non-volatile memory such as a flash memory or a hard disk drive. The controller 170 accesses the storage section 150 and performs operations such as reading, writing, revision, updating and the like.

The data stored in the storage section 150 may include an operating system for driving the display apparatus 100, and various application programs, image data, additional data and the like executable in the operating system, and the like, for example.

The storage section 150 according to the present embodiment stores a variety of information such as coordinate information for detection of a user input to the touch detecting section 131. For example, if a user's touch to the touch detecting section 131 is detected, the controller 170 may indentify the type of the detected touch input using the information stored in the storage section 150 in advance, may calculate coordinate information (X and Y coordinates) corresponding to a touched position, and may transmit the calculated coordinate information to the image processing section 110. Then, an image corresponding to the type of the identified touch input and the touched position may be displayed in the display section 120 through the image processing section 110.

The storage section 150 according to the present embodiment may further store a matching table 151 for determining the eye-gaze information, such as a eye-gaze direction.

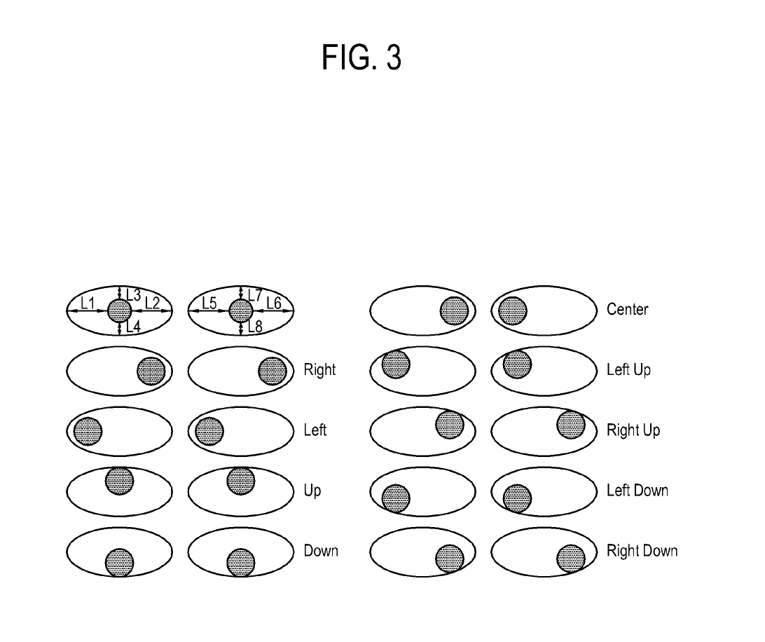

FIG. 3 illustrates an example of the matching table 151 stored in the display apparatus 100 according to the present embodiment.

As shown in FIG. 3, in a case where the eye-gaze information is the pupil direction information, plural pupil directions (hereinafter, may be referred to as pupil recognition directions) corresponding to right, left, up, down, center, left-up, right-up, left-down and right-down, for example, may be distinctly stored in the storage section 150.

According to an aspect of the present embodiment, each pupil direction may be determined using horizontal and vertical lengths L1 to L8 between the edges of the pupils of the eyes of a user and the edges of the whites thereof, as shown in FIG. 3. The pupil directions determined by the respective lengths L1 to L8 may be stored in the matching table 151 to respectively match with the above nine pupil directions, for example. For example, if L1 and L5 are larger than a reference value and L2 and L6 are smaller than a reference value, and if L3, L4, L7 and L8 are within a reference value, the pupil direction matches with the right. Similarly, if L1 and L5 are smaller than the reference value and L2 and L6 are larger than the reference value, and if L3 and L7 are larger than the reference value and L4 and L8 are smaller than the reference value, the pupil direction matches with the left-down.

The controller 170 controls the image processing section 110 to process a predetermined user image received from the image input section 140, and acquires values of L1 to L8 from the image processed in the image processing section 110. The controller 170 loads a pupil direction which matches with the acquired values of L1 to L8 from the matching table 151 to determine the pupil direction of a corresponding user.

On the other hand, in a case where the eye-gaze information is the face direction information, plural face directions corresponding to horizontal and vertical positions and rotational angles of the face of a user, including right, left, up, down, center, left-up, right-up, left-down and right-down, for example, may be distinctly stored in the storage section 150. The controller 170 may determine the face direction using information on the horizontal and vertical positions and the rotational angle acquired from the user image received through the image input section 140.

An aspect of the present embodiment, the matching table 151 may include at least one of a first matching table for the face direction information and a second matching table for the pupil direction information. In a case where both of the first and second matching tables are provided, it is possible to determine the eye-gaze direction with high accuracy.

An aspect of the present embodiment, a case where the pupil recognition direction of the user is determined using the lengths L1 to L8 and a case where the face direction of the user is determined using the horizontal and vertical positions and the rotational angle of the face have been described as examples, but the present embodiment is not limited thereto. For example, various algorithms for tracking the pupil direction or for predicting the face direction may be used.

The communicating section 160 may transmit a command, data, information and/or a signal received from the external device, for example, from the input device (not shown) provided with the touch detecting section 131 to the image processing section 110. Further, the communicating section 160 may transmit a command, data, information and/or a signal received from the controller 170 to the input device.

The communicating section 160 may perform communication between the display apparatus 100 and the input device in a wireless manner. The wireless communication may include infrared communication, RF communication, Zigbee communication, Bluetooth communication, wireless LAN communication, or the like. Further, the communicating section 160 may include a wired communication module.

An aspect of the present embodiment, the communicating section 160 is built in the display apparatus 100, but may be realized as a dongle or module type for detachable connection with a connector (not shown) of the display apparatus 100.

The controller 170 performs control operations for the various components of the display apparatus 100. For example, the controller 170 may perform a control operation for image processing in the image processing section 110, or a control operation for responding to a command received from the input device, to thereby control the overall operations of the display apparatus 100.

The display apparatus 100 according to the present embodiment is realized to detect and identify plural touch inputs of plural users.

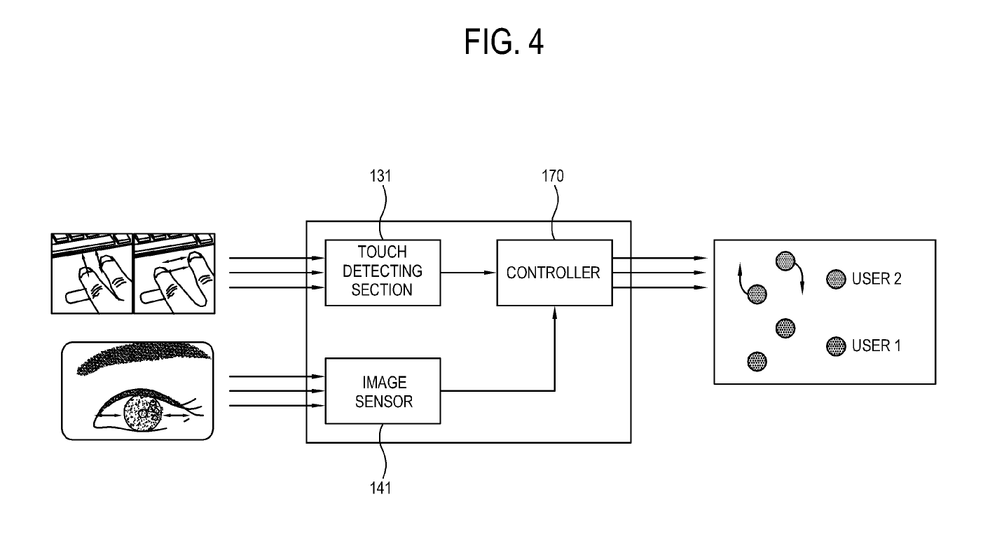

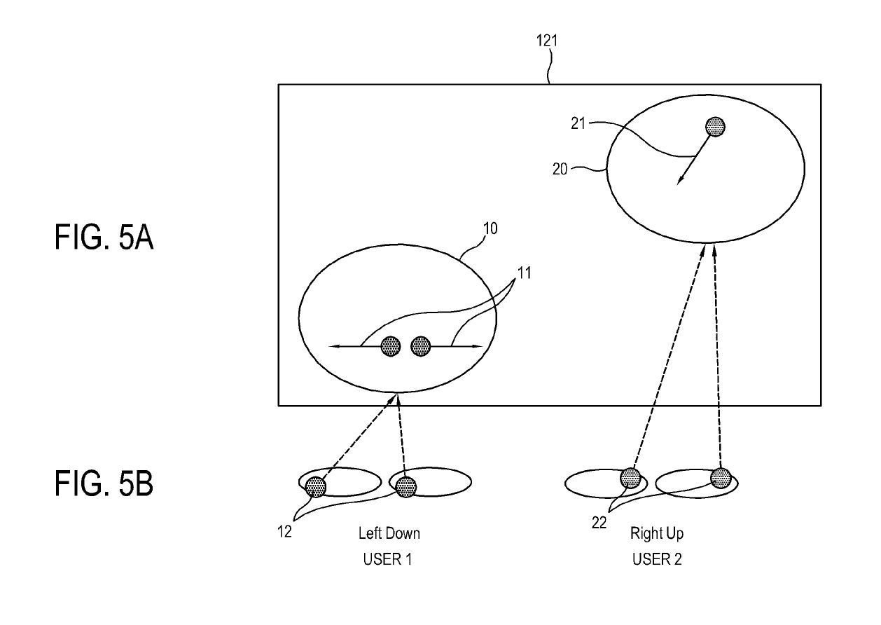

FIG. 4 illustrates a process of identifying users of plural touch inputs in the display apparatus 100 according to the present embodiment, and FIGS. 5A-5B illustrate examples in which users of plural touch inputs are identified using pupil information in the process in FIG. 4.

As shown in FIG. 4, information of a user's touch input detected in the touch detecting section 131 and information of an image detected in the image sensor 141 of the image input section 140 are transmitted to the controller 170. Here, the touch detecting section 131 may receive multi or plural touch inputs, and the image sensor 141 may receive plural user images.

The controller 170 calculates coordinate information corresponding to a touched position from the touch input information received through the touch detecting section 131. The calculated coordinate information is used to determine the touched position.

The controller 170 controls the image processing section 110 to process the user image received through the image input section 140, and determines the eye-gaze direction of the user using information of user's eye-gaze in the processed image.

Specifically, the controller 170 may acquire the values of the lengths L1 to L8 as described above from the user image, and may recognize the user's pupil direction using the acquired values of L1 to L8 and the matching table 151 to determine the eye-gaze direction. Similarly, the controller 170 may acquire information on the horizontal and vertical positions and the rotational angle of the user's face, and may recognize the user's face direction using the acquired information and/or the matching table 151 to determine the eye-gaze direction.

In this regard, the controller 170 may recognize both of the pupil direction and the face direction, and may determine, if the pupil direction and the face direction coincide with each other, the coinciding direction as the eye-gaze direction. If the pupil direction and the face direction do not coincide with each other, the controller 170 may determine the user's eye-gaze direction according to a predetermined order.

For example, as shown in FIG. 5A, the display apparatus 100 may receive, as plural touch inputs of plural users, a first touch input 11 to a left-down region 10 of the touch screen 121 from a user 1 and a second touch input 21 to a right-up region 20 of the touch screen 121.

The controller 170 calculates coordinate information on each of the first and second touch inputs 11 and 21, and determines a first touch input position of the user 1 as the left-down region 10 and a second touch input position of the user 2 as the right-up region 20.

Further, the controller 170 acquires the values of L1 to L8 from the user images, and determines a first pupil recognition direction 12 of the user 1 as left-down and a second pupil recognition direction 22 of the user 2 as right-up, using the acquired values of L1 to L8 and the matching table 151. The first and second pupil recognition directions are respectively used as information on eye-gaze directions (first and second eye-gaze directions) of the users 1 and 2.

The controller 170 determines whether touch inputs at positions corresponding to the first and second pupil recognition directions 12 and 22, that is, the first and second eye-gaze directions are present in the first and second touch inputs 11 and 21. Here, if the touch inputs at the positions corresponding to the first and second eye-gaze directions are present, and if the touch inputs 10 and 20 and the eye-gaze directions 12 and 22 coincide with each other, the controller 170 recognizes both of the first and second touch inputs 11 and 21 as valid touch inputs.

Then, the controller 170 distinguishes the users (users 1 and 2) respectively corresponding to the valid touch inputs 11 and 21, and performs operations corresponding to the detected touch inputs 11 and 21 according to the types of the detected touch inputs.

For example, the controller 170 may perform “Zoom In” for a first object for which the first touch input 11 of the user 1 in FIG. 5A is received, and may perform “Move” in the left-down direction for a second object for which the second touch input 21 of the user 2 in FIG. 5A is received. Then, the controller 170 controls the display section 120 to display an image (in which the first object is zoomed in and the second object is moved in the left-down direction) based on the operations corresponding to the respective touch inputs 11 and 21.

In FIGS. 5A and 5B, a case where the pupil direction information is used as the eye-gaze information to determine the presence of the user's touch input has been described, but the present embodiment may include a case where the face direction information is used as the eye-gaze information. That is, the controller 170 may determine whether touch inputs at positions corresponding to first and second face directions are present in the first and second touch inputs 11 and 21 to recognize valid touch inputs.

In this regard, the controller 170 may accumulate a history of matching with respect to the eye-gaze direction of each user for management in order to enhance the matching accuracy for each user. Information on the accumulated history is stored in the storage section 150. Here, the storage section 150 may further store a history of matching with respect to the pupil direction and a history of matching with respect to the face direction of each user, in addition to the history of matching with respect to the eye-gaze direction of each user. Thus, it is possible to easily determine the eye-gaze direction of a user in a case where a touch input position of a specific user is fixedly maintained in a conference, class or the like using a large-sized display, for example.

Further, the display apparatus 100 according to the present embodiment may execute plural application programs at the same time to display respective screens corresponding to the plural application programs in different areas. For example, in FIG. 5A, in a case where a screen corresponding to a first application program is to be displayed in a first area 10 and a screen corresponding to a second application program is to be displayed in a second area 20, the controller 170 may perform an operation corresponding to the first application program for the first touch input 11, and may perform an operation corresponding to the second application program for the second touch input 12.

In this way, the display apparatus 100 according to an aspect of the present embodiment may distinguish users of plural touch inputs to perform an individual interaction for each touch input.

With this configuration, for example, in a conference, class, discuss or the like using a large-sized display such as a tabletop computer or an interactive whiteboard (IWB), plural users can share touch inputs and corresponding content, thereby enhancing convenience of the users.

Hereinafter, a control method of the display apparatus 100 according to an aspect of the present embodiment will be described with reference to the accompanying drawings.

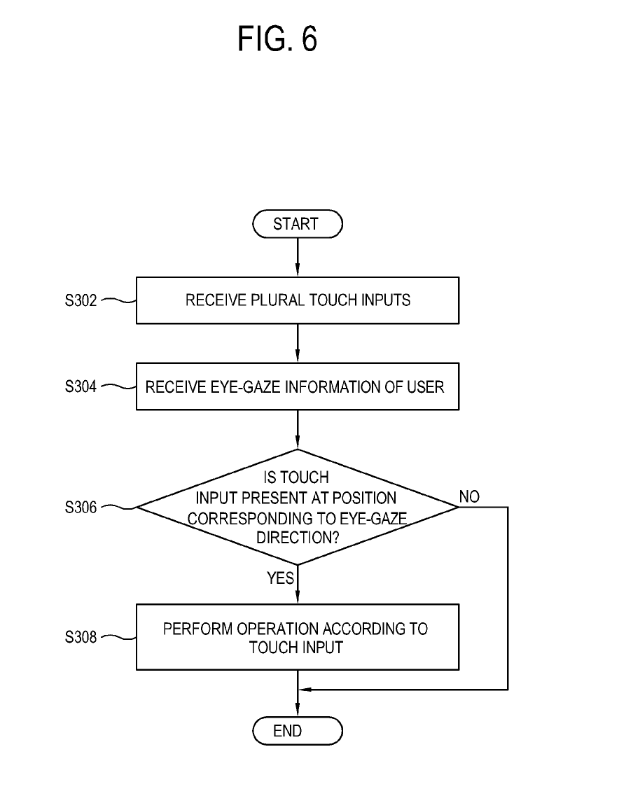

FIG. 6 is a flowchart illustrating a control method of the display apparatus 100 according to an aspect of the present embodiment.

As shown in FIG. 6, the display apparatus 100 may receive plural touch inputs through the touch detecting section 131 (S302). Here, the received plural touch inputs may be touch inputs of plural users.

The display apparatus 100 may further receive eye-gaze information of a user through the image input section 140 such as a camera (S304). Here, the controller 170 may acquire the values of L1 to L8 (see FIG. 3) from a user image received through the image input section 140 to load a pupil recognition direction which matches with the values of L1 to L8 from the matching table 151, or may acquire information on horizontal and vertical positions and a rotational angle of the face to load a face direction which matches with the information, to thereby determine the eye-gaze direction of the user.

Then, the controller 170 determines whether a touch input at a position corresponding to the eye-gaze direction in S304 is present in the received plural touch inputs (S306).

If the determination result in S306 is yes, the controller 170 determines the touch input at a touch input position which coincides with the eye-gaze direction as a valid touch input, and performs an operation according to the valid touch input (S308).

As described above, according to the exemplary embodiment, it is possible to identify a user using an eye-gaze direction of the user for plural touch inputs to perform an operation corresponding to a touch input of the identified user, to thereby provide a display apparatus capable of distinguishing plural touch inputs of plural users.

Thus, the display apparatus can perform an individual interaction according to a touch input of each user.

The apparatus and methods according to the above-described example embodiments may use one or more processors. For example, a processing device may be implemented using one or more general-purpose or special purpose computers, such as, for example, a processor, an image processor, a controller and an arithmetic logic unit, a central processing unit (CPU), a graphics processing unit (GPU), a digital signal processor (DSP), a microcomputer, a field programmable array, a programmable logic unit, an application-specific integrated circuit (ASIC), a microprocessor or any other device capable of responding to and executing instructions in a defined manner.

The terms “module”, and “unit,” as used herein, may refer to, but are not limited to, a software or hardware component or device, such as a Field Programmable Gate Array (FPGA) or Application Specific Integrated Circuit (ASIC), which performs certain tasks. A module or unit may be configured to reside on an addressable storage medium and configured to execute on one or more processors. Thus, a module or unit may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules/units may be combined into fewer components and modules/units or further separated into additional components and modules.

Some example embodiments of the present disclosure can also be embodied as a computer readable medium including computer readable code/instruction to control at least one component of the above-described example embodiments. The medium may be any medium that can storage and/or transmission the computer readable code.

Aspects of the above-described example embodiments may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the example embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. The media may be transfer media such as optical lines, metal lines, or waveguides for transmitting a signal designating the program command and the data construction. Examples of program instructions include both machine code, such as produced by a compiler, and files containing higher level code that may be executed by the computer using an interpreter. The described hardware devices may be configured to act as one or more software modules in order to perform the operations of the above-described example embodiments, or vice versa. In addition, a non-transitory computer-readable storage medium may be distributed among computer systems connected through a network and computer-readable codes or program instructions may be stored and executed in a decentralized manner. In addition, the computer-readable storage media may also be embodied in at least one application specific integrated circuit (ASIC) or Field Programmable Gate Array (FPGA). Some or all of the operations performed according to the above-described example embodiments may be performed over a wired or wireless network, or a combination thereof.

Each block of the flowchart illustrations may represent a unit, module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved. Also, while an illustration may show an example of the direction of flow of information for a process, the direction of flow of information may also be performed in the opposite direction for a same process or for a different process. Although a few exemplary embodiments have been shown and described, it will be appreciated by those skilled in the art that changes may be made in these exemplary embodiments without departing from the principles and spirit of the invention, the scope of which is defined in the appended claims and their equivalents.

What is claimed is:

1. A display apparatus comprising:
a display section which displays an image;
a touch detecting section which receives a plurality of touch inputs from a user;
an image input section which receives an image; and
a controller which performs operations corresponding to the plurality of received touch inputs using information on the touch inputs received through the touch detecting section and eye-gaze information of the user received through the image input section.

2. The display apparatus according to claim 1,
wherein the eye-gaze information comprises at least one of face direction information and pupil direction information.

3. The display apparatus according to claim 1,
wherein the controller determines whether a touch input at a position corresponding to a face direction or a pupil direction is present for each of the plurality of touch inputs, and identifies a user corresponding to each of the plurality of touch inputs on the basis of the determination.

4. The display apparatus according to claim 1, further comprising:
a storage section which stores a matching table for determination of a face direction or a pupil direction,
wherein the controller acquires information from a user image received through the image input section, and loads the face direction and/or the pupil direction which matches with the acquired information from the matching table to determine the eye-gaze direction of the user.

5. The display apparatus according to claim 4,
wherein in a case where the eye-gaze information is the pupil direction information, the controller acquires information on horizontal and vertical lengths between the edge of a pupil of a user's eye and the edge of a white thereof from the user image, and loads a pupil direction which matches with the acquired the lengths information from the matching table to determine the pupil direction of the user.

6. The display apparatus according to claim 4,
wherein the eye-gaze direction of the user comprises directions of right, left, up, down, center, left-up, right-up, left-down and right-down, which are distinctly stored in the matching table.

7. The display apparatus according to claim 4,
wherein in a case where the eye-gaze information is the face direction information, the controller determines the face direction of the user using at least one of a horizontal position, a vertical position and a rotational angle of a face in the user image received through the image input section.

8. The display apparatus according to claim 4,
wherein the storage section further stores a history of matching for the face direction or the pupil direction of the user.

9. The display apparatus according to claim 1,
wherein the controller determines a touch input of which the position matches with an eye-gaze direction corresponding to the eye-gaze information, among the plurality of touch inputs, as a valid touch input.

10. The display apparatus according to claim 9,
wherein the controller identifies the type of the valid touch input, performs an operation corresponding to the identified type of the valid touch input, and controls the display section to display an image corresponding to the performed operation.

11. The display apparatus according to claim 10,
wherein the valid touch input comprises a first touch input for a first object and a second touch input for a second object, and
wherein the controller performs an operation corresponding to the first touch input for the first object and performs an operation corresponding to the second touch input for the second object.

12. A control method of a display apparatus, comprising:
receiving a plurality of touch inputs from a user;
receiving eye-gaze information of the user; and
performing operations corresponding to the plurality of received touch inputs using information of the received touch inputs and the eye-gaze information of the user.

13. The method according to claim 12,
wherein the eye-gaze information comprises at least one of face direction information and pupil direction information.

14. The method according to claim 13, further comprising:
determining whether a touch input at a position corresponding to a face direction or a pupil direction is present for each of the plurality of touch inputs; and
identifying a user corresponding to each of the plurality of touch inputs on the basis of the determination.

15. The method according to claim 14, further comprising:
storing a matching table for determination of the face direction and/or the pupil direction,
wherein the determination of the presence of the touch input comprises acquiring information from a user image, and loading a face direction and/or a pupil direction which matches with the acquired information from the matching table to determine an eye-gaze direction of the user.

16. The method according to claim 15,
wherein in a case where the eye-gaze information is the pupil direction information, the acquisition of the information comprises acquiring information on horizontal and vertical lengths between the edge of a pupil of a user's eye and the edge of a white thereof from the user image, and the determination of the eye-gaze direction comprises loading a pupil direction which matches with the acquired lengths information from the matching table to determine the pupil direction of the user.

17. The method according to claim 15,
wherein the eye-gaze direction of the user comprises directions of right, left, up, down, center, left-up, right-up, left-down and right-down, which are distinctly stored in the matching table.

18. The method according to claim 17,
wherein in a case where the eye-gaze information is the face direction information, the determination of the eye-gaze direction comprises determining the face direction of the user using at least one of a horizontal position, a vertical position and a rotational angle of a face in the user image.

19. The method according to claim 12, further comprising:
storing a history of matching for a face direction and/or a pupil direction of the user.

20. The method according to claim 12, further comprising:
determining a touch input of which the position matches with an eye-gaze direction corresponding to the eye-gaze information, among the plurality of touch inputs, as a valid touch input.

21. The method according to claim 20, further comprising:
identifying the type of the valid touch input;
performing an operation corresponding to the identified type of the valid touch input; and
displaying an image corresponding to the performed operation.

22. The method according to claim 21,
wherein the valid touch input comprises a first touch input for a first object and a second touch input for a second object, and
wherein the performance of the operation comprises performing an operation corresponding to the first touch input for the first object and performing an operation corresponding to the second touch input for the second object.
